(19) United States
(12) Patent Application Publication
(10) Pub. No.: US 2009/0184936 A1
(43) Pub. Date: Jul. 23, 2009

(54) 3D touchpad

(75) Inventor: Cherif Atia Algreatly, Newark, CA (US)

Correspondence Address: CHERIF ATIA ALGREATLY, MATHEMATICAL INVENTING- SILICON VALLEY, 39962 CEDAR BLVD - SUITE 286, NEWARK, CA, 94560, US

(73) Assignee: MATHEMATICAL INVENTING - SLICON VALLEY, Newark, CA (US)

(21) Appl. No.: 12/321,561

(22) Filed: Jan. 21, 2009

Related U.S. Application Data
(60) Provisional application No. 61/011,811, filed on Jan. 22, 2008.
(60) Provisional application No. 61/063,195, filed on Feb. 2, 2008.
(60) Provisional application No. 61/063,672, filed on Feb. 4, 2008.

(51) Int. Cl. G06F 3/041

(52) U.S. Cl. 345/173

(57) ABSTRACT

A 3D touchpad that is comprised of a first touchpad, a second touchpad, and a third touchpad that are positioned to be parallel to the xy, yz, and xz-plane, wherein moving the user's finger on said 3D touchpad provides six degrees-of-freedom to the computer system. Said computer input device can be incorporated onto the top of a computer mouse, a computer keyboard, a game controller, or the like.

### CROSS-REFERENCE TO RELATED APPLICATION

This application claims the benefits of U.S. Provisional Applications No. 61/011,811, filed on Jan. 22, 2008, No. 61/063,195, filed on Feb. 2, 2008, and No. 61/063,672, filed on Feb. 4, 2008.

### BACKGROUND

The traditional touchpad is usually used to replace the computer mouse to manipulate objects to move in two dimensions on the computer display. The present invention introduces a 3D touchpad that allows the user to manipulate objects to move in three dimensions on the computer display.

Moreover, the present 3D touchpad enables the user to provide six degrees-of-freedom (6FOF) to the computer system to move or rotate objects along/about the x, y, and z-axis on the computer display in an intuitive manner.

### SUMMARY

In one embodiment of the present invention, a 3D touchpad can comprise a first touchpad that is positioned to be parallel to the xy-plane, a second touchpad that is positioned to be parallel to the xz-plane, and a third touchpad that is positioned to be parallel to the yz-plane.

Each one of the first touchpad, second touchpad, and third touchpad provides an immediate input to the computer system representing a movement along two axes or a rotation about an axis when the user's finger is moved on its surface in specific directions.

In other embodiment of the present invention, a 3D touchpad can comprise a first touchpad that is positioned to be parallel to the xz-plane, and a second touchpad that is positioned to be parallel to the yz-plane.

Each one of the first touchpad and the second touchpad provides an immediate input to the computer system representing a movement or a rotation along/about an axis when a first finger is moved on its surface while a second finger is touching the other touchpad.

The present invention of the 3D touchpad can be incorporated onto the top of a computer mouse where the movement of the computer mouse on a surface manipulates the cursor to move in 2D on the computer display, while the present 3D touchpad provides the computer system with six degrees-of-freedom to move or rotate objects along/about the x, y, or z-axis on the computer display.

The present invention of the 3D touchpad can also be incorporated onto the top of a computer keyboard, a ring mouse, or other computer input devices to enable the computer keyboard, the ring mouse, or the other computer input devices to provide six degrees-of-freedom to the computer system.

### BRIEF DESCRIPTION OF THE DRAWINGS

FIG. 1 is the present invention of the 3D touchpad.

FIG. 2 is moving the user's finger horizontally from “left” to “right” on the first touchpad.

FIG. 3 is moving the user's finger horizontally from “right” to “left” on the first touchpad.

FIG. 4 is moving the user's finger vertically from “down” to “up” on the first touchpad.

FIG. 5 is moving the user's finger vertically from “up” to “down” on the first touchpad.

FIG. 6 is moving the user's finger in a clockwise rotation on the first touchpad.

FIG. 7 is moving the user's finger in a counter-clockwise rotation on the first touchpad.

FIG. 8 is moving the user's finger horizontally backward on the second touchpad.

FIG. 9 is moving the user's finger horizontally forward on the second touchpad.

FIG. 10 is moving the user's finger vertically from “down” to “up” on the second touchpad.

FIG. 11 is moving the user's finger vertically from “up” to “down” on the second touchpad.

FIG. 12 is moving the user's finger in a clockwise rotation on the second touchpad.

FIG. 13 is moving the user's finger in a counter-clockwise rotation on the second touchpad.

FIG. 14 is moving the user's finger horizontally from “left” to “right” on the third touchpad.

FIG. 15 is moving the user's finger horizontally from “right” to “left” on the third touchpad.

FIG. 16 is moving the user's finger vertically backward on the third touchpad.

FIG. 17 is moving the user's finger vertically forward on the third touchpad.

FIG. 18 is moving the user's finger in a clockwise rotation on the third touchpad.

FIG. 19 is moving the user's finger in a counter-clockwise rotation on the third touchpad.

FIG. 20 is another form of the present invention of the 3D touchpad.

FIG. 21 is a tilt scroll wheel that can be rotated or tilted about/along the x-axis.

FIG. 22 is a tilt scroll wheel that can be rotated or tilted about/along the y-axis.

FIG. 23 is a tilt scroll wheel that can be rotated or tilted about/along the z-axis.

FIG. 24 is the surfaces of the first, second, and third touchpad in a form of scroll wheels.

FIG. 25 is the present 3D touchpad comprised of three touch-pads attached to a computer keyboard.

FIG. 26 is the present 3D touchpad comprised of two touch-pads attached to a computer keyboard.

### DETAILED DESCRIPTION

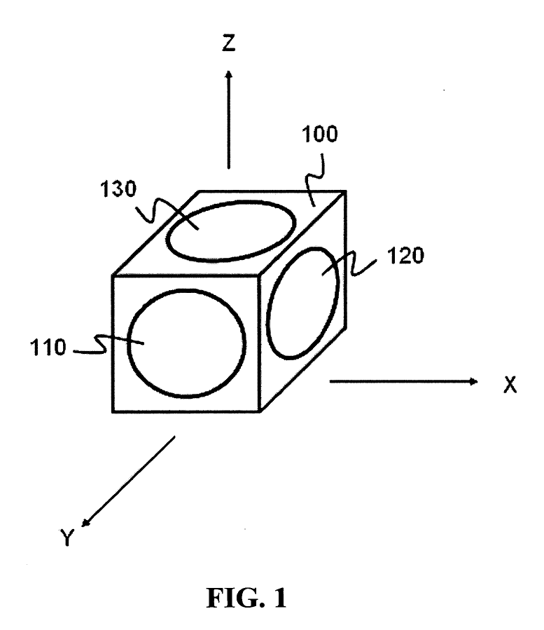

FIG. 1 illustrates the present invention of the 3D touchpad which is comprised of a cube 100 that functions as a chassis containing the components of the present invention, a first touchpad 110, a second touchpad 120, and a third touchpad 130.

The first touchpad, the second touchpad, and the third touchpad are incorporated onto three faces of the cube, where the first touchpad is positioned to be parallel to the xz-plane, the second touchpad is positioned to be parallel to the yz-plane, and the third touchpad is positioned to be parallel to the xy-plane.

The user can utilize three fingers to operate the present 3D touchpad. For example, the user can move the thumb finger on the first touchpad, the middle finger on the second touchpad, and the index finger on the third touchpad.

FIG. 2 illustrates moving the thumb finger horizontally 140, from “left” to “right” on the first touchpad to provide an immediate input to the computer system representing a movement along the positive x-axis.

FIG. 3 illustrates moving the thumb finger horizontally 150, from “right” to “left” on the first touchpad to provide an immediate input to the computer system representing a movement along the negative x-axis.

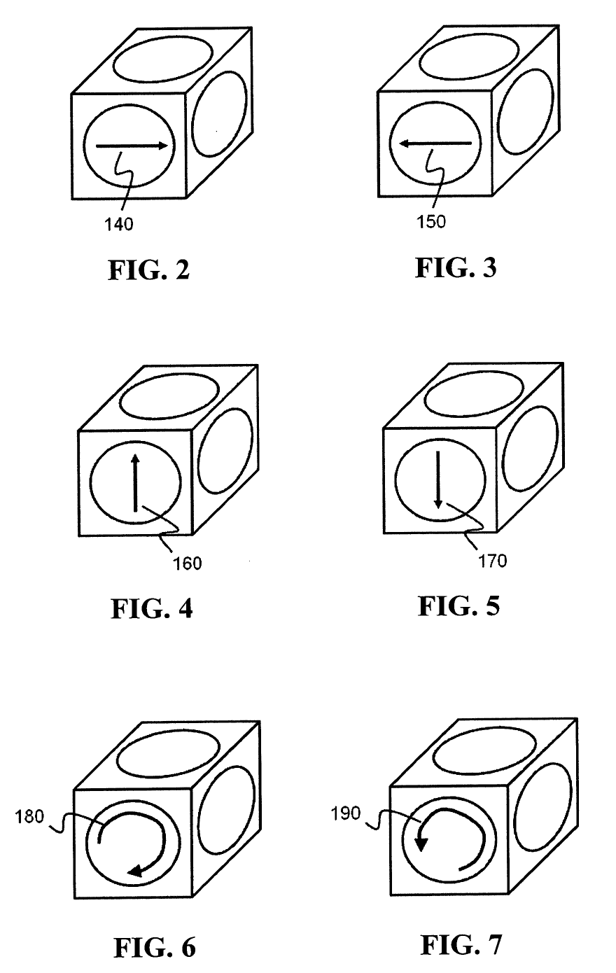

FIG. 4 illustrates moving the thumb finger vertically 160, from “down” to “up” on the first touchpad to provide an immediate input to the computer system representing a movement along the positive z-axis.

FIG. 5 illustrates moving the thumb finger vertically 170, from “up” to “down” on the first touchpad to provide an immediate input to the computer system representing a movement along the negative z-axis.

FIG. 6 illustrates moving the thumb finger in a clockwise rotation 180 on the first touchpad to provide an immediate input to the computer system representing a clockwise rotation about the y-axis.

FIG. 7 illustrates moving the thumb finger in a counter-clockwise rotation 190 on the first touchpad to provide an immediate input to the computer system representing a counter-clockwise rotation about the y-axis.

FIG. 8 illustrates moving the middle finger horizontally backward 200 on the second touchpad to provide an immediate input to the computer system representing a movement along the positive y-axis.

FIG. 9 illustrates moving the middle finger horizontally forward 210 on the second touchpad to provide an immediate input to the computer system representing a movement along the negative y-axis.

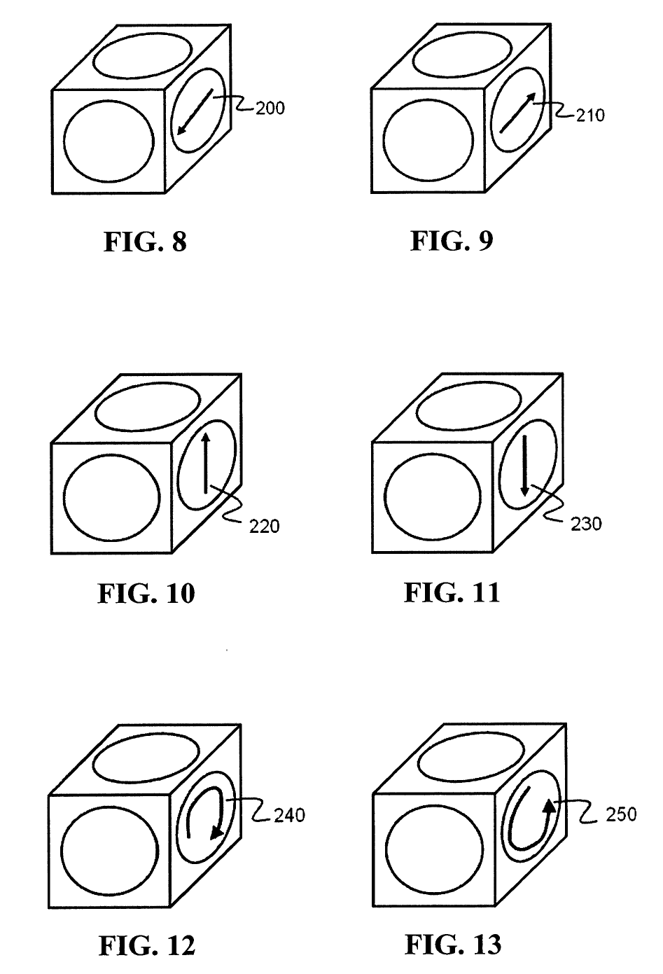

FIG. 10 illustrates moving the middle finger vertically 220, from “down” to “p” on the second touchpad to provide an immediate input to the computer system representing a movement along the positive z-axis.

FIG. 11 illustrates moving the middle finger vertically 230, from “up” to “down” on the second touchpad to provide an immediate input to the computer system representing a movement along the negative z-axis.

FIG. 12 illustrates moving the middle finger in a clockwise rotation 240 on the second touchpad to provide an immediate input to the computer system representing a clockwise rotation about the x-axis.

FIG. 13 illustrates moving the middle finger in a counter-clockwise rotation 250 on the second touchpad to provide an immediate input to the computer system representing a counter-clockwise rotation about the x-axis.

FIG. 14 illustrates moving the index finger horizontally 260, form “left” to “right” on the third touchpad to provide an immediate input to the computer system representing a movement along the positive x-axis.

FIG. 15 illustrates moving the index finger horizontally 270, form “right” to “left” on the third touchpad to provide an immediate input to the computer system representing a movement along the negative x-axis.

FIG. 16 illustrates moving the index finger horizontally backward 280 on the third touchpad to provide an immediate input to the computer system representing a movement along the positive y-axis.

FIG. 17 illustrates moving the index finger horizontally forward 290 on the third touchpad to provide an immediate input to the computer system representing a movement along the negative y-axis.

FIG. 18 illustrates moving the index finger in a clockwise rotation 300 on the third touchpad to provide an immediate input to the computer system representing a clockwise rotation about the z-axis.

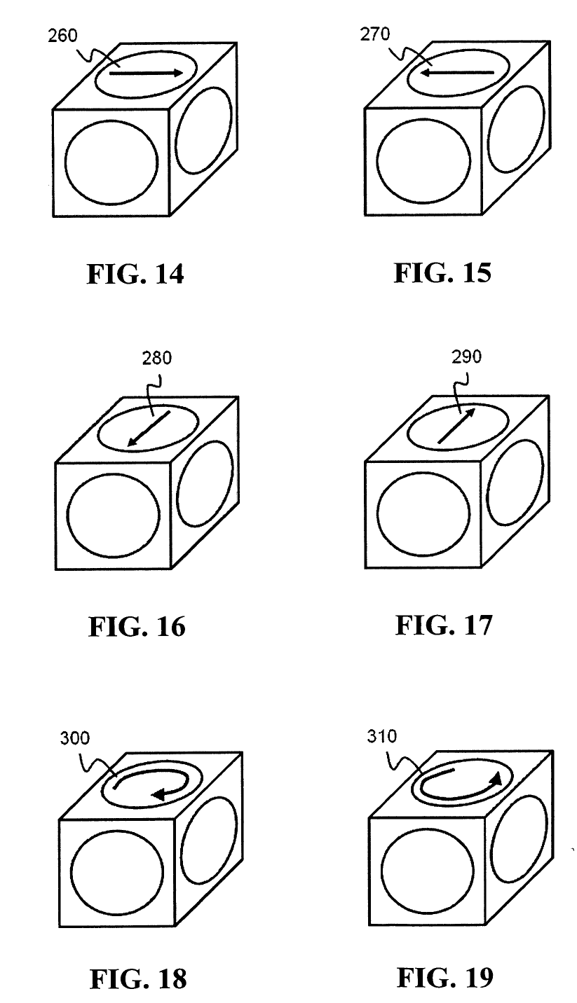

FIG. 19 illustrates moving the index finger in a counter-clockwise rotation 310 on the third touchpad to provide an immediate input to the computer system representing a counter-clockwise rotation about the z-axis.

According to the previous description, the user of the present 3D touchpad can provide an immediate input to the computer system representing a movement along the x-axis by moving his/her finger on the first touchpad or the third touchpad.

The user of the present 3D touchpad can provide an immediate input to the computer system representing a movement along the y-axis by moving his/her finger on the second touchpad or the third touchpad.

The user of the present 3D touchpad can provide an immediate input to the computer system representing a movement along the z-axis by moving his/her finger on the first touchpad or the second touchpad.

The user of the present 3D touchpad can provide an immediate input to the computer system representing a rotation about the x-axis, the y-axis, or the z-axis by, respectively, rotating his/her finger on the second touchpad, the first touchpad, or the third touchpad.

The time elapsed when moving or rotating objects along/about the x, y, or z-axis on the computer display is the same amount of time the user's finger keeps touching the first touchpad, the second touchpad, or the third touchpad even after stopping the movement of the user's finger on the present 3D touchpad.

The possibility of operating the present 3D touchpad without a finger movement eliminates the user's need to reposition his/her finger to move objects for a large distance on the computer display, whereas in this case the user does not reach the dead ends of the present 3D touchpad surface.

To control the speed of moving/rotating objects on the computer display a pressure-sensitive touchpad is utilized to enable the present 3D touchpad to detect the finger pressure while touching or moving on the first touchpad, the second touchpad, or the third touchpad. In this case, the value of the finger pressure represents the speed of moving/rotating objects on the computer display.

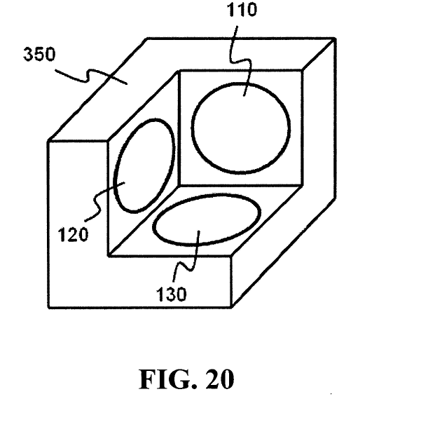

FIG. 20 illustrates another form for the chassis 350 of the present 3D touchpad where the first touchpad 110, the second touchpad 120, and the third touchpad 130 are positioned as illustrated in the figure to enable the user to operate the present 3D touchpad using one finger only instead of using three fingers.

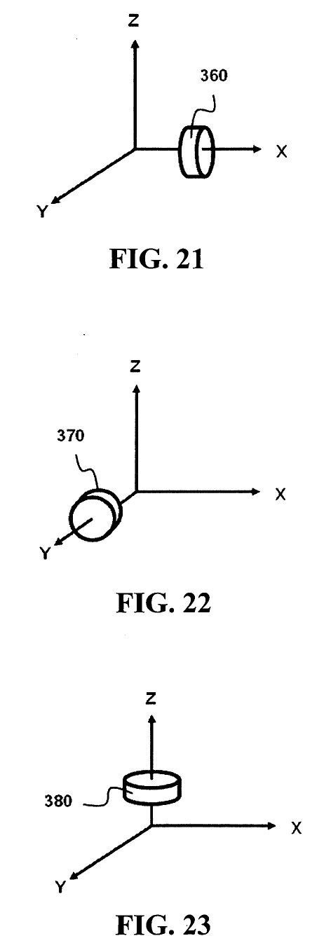

FIGS. 21 to 23 illustrate another concept for operating the present 3D touchpad. As shown in figures, FIG. 21 illustrates a tilt-scroll wheel 360 that can be rotated clockwise or counter-clockwise about the x-axis to represent a rotation about the x-axis, and can be tilted from “left” to “right” or from “right” to “left” to represent a movement along the x-axis.

FIG. 22 illustrates a tilt-scroll wheel 370 that can be rotated clockwise or counter-clockwise about the y-axis to represent a rotation about the y-axis, and can be tilted forward or backward to represent a movement along the y-axis.

FIG. 23 illustrates a tilt-scroll wheel 380 that can be rotated clockwise or counter-clockwise about the z-axis to represent a rotation about the z-axis, and can be tilted form “down” to “up” or from “up” to “down” to represent a movement along the z-axis.

This concept of operating the three tilt-scroll wheels can be utilized with the present 3D touchpad by making the first touchpad functioning similar to the tilt-scroll wheel of FIG. 21, the second touchpad functioning similar to the tilt-scroll wheel of FIG. 23, and the third scroll wheel functioning similar to the tilt-scroll wheel of FIG. 22.

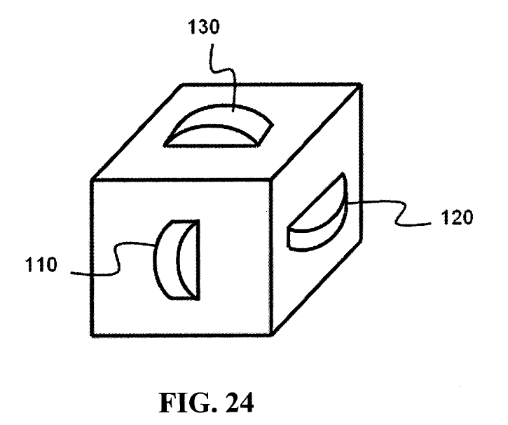

FIG. 24 illustrates curving the surfaces of the first touchpad 110, the second touchpad 120, and the third touchpad 130 in a manner that gives the user a feeling of moving his/her finger on scroll wheels similar to the tilt-scroll wheels of FIGS. 21 to 23.

In this case, as shown in FIG. 24, moving the user's finger form “down” to “up”, or from “up” to “down” on the first touchpad 110 respectively represents a clockwise rotation about the x-axis, or a counter-clockwise rotation about the x-axis. Moving the user's finger from “left” to “right’ or from “right” to “left” on the first touchpad respectively represents a movement along the positive x-axis, or the negative x-axis.

Moving the user's finger from “left” to “right”, or from “right” to “left” on the third touchpad 130 respectively represents a clockwise rotation about the y-axis, or a counter clockwise rotation about the y-axis. Moving the user's finger backward or forward on the third touchpad respectively represents a movement along the positive y-axis, or the negative y-axis.

Moving the user finger backward or forward on the second touchpad 120 respectively represents a clockwise rotation about the z-axis, or a counter-clockwise rotation about the z-axis. Moving the user's finger from “down” to “up”, or from “up” to “down” on the second touchpad respectively represents a movement along the positive z-axis, or the negative z-axis.

Generally, the present 3D touchpad enables the user to provide two simultaneous inputs to the computer system by simultaneously moving two fingers on the first touchpad and the second touchpad, or the first touchpad and the third touchpad, or the second touchpad and the third touchpad. Accordingly, for example, the user can rotate an object about the x-axis while s/he is moving this object along the z-axis on the computer display.

Providing two simultaneous inputs to the computer system can also be utilized to simultaneously move two different objects on the computer display. For example, in some gaming applications the user can move a virtual character on the computer display while s/he is moving/rotating the virtual camera relative to this virtual character.

However, providing six degrees-of-freedom to the computer system can be achieved by using two touch-pads instead of three touch-pads. For example, it is possible to only utilize the first touchpad and the second touchpad, or the first touchpad and the third touchpad, or the second touchpad and the third touchpad of the present invention to provide six degrees of freedom to the computer system.

For example, when utilizing the first touchpad and the second touchpad, in this case, moving the user's finger horizontally from “left” to “right”, or from “right” to “left” on the first touchpad respectively provides an immediate input to the computer system representing a movement along the positive x-axis, or the negative x-axis.

Moving the user's finger horizontally backward or forward on the second touchpad respectively provides an immediate input to the computer system representing a movement along the positive y-axis, or the negative y-axis.

Moving the user's finger vertically from “down” to “up”, or from “up” to down” on the first touchpad or the second touchpad respectively provides an immediate input to the computer system representing a movement along the positive z-axis, or the negative z-axis.

Moving a finger vertically from “down” to “up”, or from “up” to “down” on the first touchpad while touching the second touchpad with another finger respectively provides an immediate input to the computer system representing a clockwise rotation about the x-axis, or a counter-clockwise rotation about the x-axis.

Moving a finger vertically from “up” to “down”, or from “down” to “up” on the second touchpad while touching the first touchpad with another finger respectively provides an immediate input to the computer system representing a clockwise rotation about the y-axis, or a counter-clockwise rotation about the y-axis.

Moving a finger horizontally backward or forward on the second touchpad while touching the first touchpad with another finger respectively provides an immediate input to the computer system representing a clockwise rotation about the z-axis, or a counter-clockwise rotation about the z-axis.

The previous description presents using the present 3D touchpad to provide six degrees-of-freedom to the computer system, however, the present 3D touchpad enables the user to manipulate objects to move in specific 3D directions on the computer display.

In this case the present 3D touchpad provides the computer system with the values of the two components θ, and φ of the spherical coordinate system, where θ represents the angle between the positive x-axis and the direction of the 3D movement projected onto the xy-plane, while φ represents the angle between the xy-plane and the direction of the 3D movement.

In this case, moving the user's finger on the third touchpad in a clockwise rotation or a counter-clockwise rotation relative to the positive x-axis provides an input to the computer system representing the value of θ, while moving the user's finger in a linear fashion on the second touchpad relative to the xy-plane provides an input to the computer system representing the value of φ.

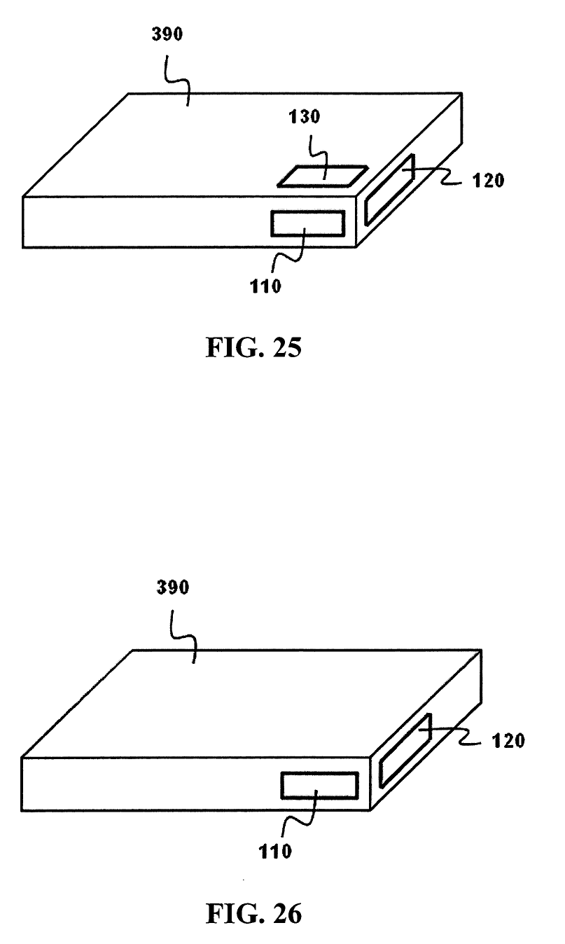

As mentioned previously the present invention of 3D touchpad can be incorporated onto the top of a computer keyboard. For example, FIG. 25 illustrates the first touchpad 110, the second touchpad 120, and the third touchpad 130 of the present invention attached to three sides of a computer keyboard 390 when utilizing three touch-pads to provide six degrees-of-freedom to the computer system.

FIG. 26 illustrates the first touchpad 110 and the second touchpad 120 of the present invention attached to two sides of a computer keyboard 390 when utilizing two touch-pads to provide six degrees-of-freedom to the computer system as previously described.

The present invention can be incorporated onto the top of various computer input devices such as a computer mouse, a ring mouse, a trackball, a game controller, or the like to provide six degrees-of-freedom to the computer system, or to manipulate objects to move in specific 3D directions on the computer display.

Overall, the main advantage of the present invention is utilizing an existing hardware technology that is simple and straightforward which easily and inexpensively carries out the present 3D touchpad.

For example, the first touchpad, the second touchpad, and the third touchpad are capacitive touch-pads that detect the location of the finger along the length and width of the pad similar to the traditional laptop touchpad.

In case of the need to control the speed of moving/rotating objects on the computer display by measuring the applied finger pressure or force on the surface of the present 3D touchpad, in this case, each one of the first touchpad, the second touchpad, and the third touchpad will be a pressure-sensitive touchpad, as known in the art, that can detect the applied finger pressure or force on its surface during the finger touch or movement.

In case of the need to form the surface of the first touchpad, the second touchpad, the third touchpad in a curved-shape or fashion as illustrated in FIG. 24, in this case a “flex PCB” will be used instead of the standard rigid PCB. A flex PCB, as known in the art, is basically a laminate of several layers of thin polyimide with conductive traces deposited on it, so it works just like a regular PCB but is flexible.

1. A computer input device that can be operated by the thumb finger, the middle finger, and the index finger to provide six degrees-of-freedom to the computer system wherein said computer input device is comprised of:
a) a chassis 100 that contains the components of said computer input device.
b) a first touchpad 110 that is positioned to be parallel to the xz-plane where moving the thumb finger on its surface horizontally 140 from “left” to “right” represents a movement along the positive x-axis, and horizontally 150 from “right” to “left” represents a movement along the negative x-axis, and moving the thumb finger on its surface in a clockwise rotation 180 represents a clockwise rotation about the y-axis, and in a counter-clockwise rotation 190 represents a counter-clockwise rotation about the y-axis.
c) a second touchpad 120 that is positioned to be parallel to the yz-plane where moving the middle finger on its surface vertically 220 from “down” to “up” represents a movement along the positive z-axis, and vertically 230 from “up” to “down” represents a movement along the negative z-axis, and moving the middle finger on its surface in a clockwise rotation 240 represents a clockwise rotation about the x-axis, and in a counter-clockwise rotation represents a counter-clockwise rotation about the x-axis.
d) a third touchpad 130 that is positioned to be parallel to the xy-plane where moving the index finger on its surface horizontally backward 280 represents a movement along the positive y-axis, and horizontally forward 290 represents a movement along the negative y-axis, and moving the index finger on its surface in a clockwise rotation 300 represents a clockwise rotation about the z-axis, and in a counter-clockwise rotation 310 represents a counter-clockwise rotation about the z-axis.

2. A computer input device that can be operated by a first finger and a second finger to provide six degrees-of-freedom to the computer system wherein said computer input device is comprised of a first touchpad that is positioned to be parallel to the xz-plane, and a second touchpad that is positioned to be parallel to the yz-plane whereas:
a) moving said first finger horizontally from “left” to “right” on said first touchpad represents a movement along the positive x-axis, and from “right” to “left” represents a movement along the negative x-axis.
b) moving said second finger horizontally backward on said second touchpad represents a movement along the positive y-axis, and forward represents a movement along the negative y-axis.
c) moving said first finger vertically from “down” to “up” on said first touchpad represents a movement along the positive z-axis, and from “up” to “down” represents a movement along the negative z-axis.
d) moving said first finger vertically from “down” to “up” on said first touchpad while touching said second touchpad with said second finger represents a clockwise rotation about the x-axis, and moving said first finger vertically from “up” to “down’ on said first touchpad while touching said second touchpad with said second finger represents a counter-clockwise rotation about the x-axis.
e) moving said second finger vertically from “up” to “down” on said second touchpad while touching said first touchpad with said first finger represents a clockwise rotation about the y-axis, and moving said second finger vertically from “down” to “up” on said second touchpad while touching said first touchpad with said first finger represents a counter-clockwise rotation about the y-axis.
f) moving said second finger horizontally backward on said second touchpad while touching said first touchpad with said first finger represents a clockwise rotation about the z-axis, and moving said second finger horizontally forward on said second touchpad while touching said first touchpad with said first finger represents a counter-clockwise rotation about the z-axis.

3. The computer input device of claim 1 wherein rotating the index finger on said third touchpad relative to the positive x-axis provides a first input to the computer system, and moving the middle finger on said second touchpad in a linear fashion relative to the xy-plane provides a second input to the computer system, whereas as said first input and said second input, respectively, represent the two components θ and φ of the spherical coordinate system that indicate the direction of moving an object in three-dimensions on the computer display.

4. The computer input device of claim 1 wherein the surface of said first touchpad, said second touchpad, and said third touchpad are curved in a manner that gives the user's finger a feeling of touching a scroll wheel.

5. The computer input device of claim 1 wherein said first touchpad, said second touchpad, and said third touchpad are positioned relative to each other to enable the user to operate said computer input device by using one finger only.

6. The computer input device of claim 1 wherein the elapsed time when the user's finger keeps touching said first touchpad, said second touchpad, or said third touchpad is the same time period of moving or rotating objects on the computer display.

7. The computer input device of claim 1 wherein said first touchpad, said second touchpad, and said third touchpad are capacitive touch-pads.

8. The computer input device of claim 1 wherein said first touchpad, said second touch pad, and said third touchpad are pressure-sensitive touch-pads that detect the applied pressure or force of the user's finger on its surface during the finger touch or movement.

9. The computer input device of claim 1 wherein said computer input device provides two simultaneous inputs to the computer system by simultaneously moving two fingers on said first touchpad, said second touchpad, and said third touchpad.

10. The computer input device of claim 1 wherein said computer input device is incorporated onto the top of a computer mouse, a ring mouse, a computer keyboard, a trackball, a game controller, or the like.

11. The computer input device of claim 8 wherein said applied pressure or force of the user's finger represents the speed of moving or rotating an object on the computer display.

12. The computer input device of claim 9 wherein said two simultaneous inputs represent moving two objects simultaneously on the computer display.
